(19) United States
(12) Patent Application Publication
(10) Pub. No.: US 2019/0147352 A1
(43) Pub. Date: May 16, 2019

(54) Causation-Based Knowledge System With Test Overlays and Loop Solution

(71) Applicant: Gavin Ovsak, Hopkins, MN (US)

(72) Inventor: Gavin Ovsak, Hopkins, MN (US)

(73) Assignee: Medical Digital Intelligence, LLC, Hopkins, MN (US)

(21) Appl. No.: 15/963,205

(22) Filed: Apr. 26, 2018

Related U.S. Application Data
(60) Provisional application No. 62/587,098, filed on Nov. 16, 2017.

(51) Int. Cl. G06N 5/02; G06N 7/00

(52) U.S. Cl. CPC G06N 5/022; G06N 7/005

(57) ABSTRACT

A system and method are presented that alters known techniques for knowledge representation and analysis in computerized expert systems. Nodes contain a value. Connections between nodes use source node values to impact the values of target nodes. Percentages are assigned to different target impacts for a single source node value. Analysis programming determines a probabilistic set of root nodes by analyzing potential impacts of parent/source nodes to alter the default value of a target node. Effect propagation is used to determine non-default values of other undetected nodes predicted by the root cause node having a required value. Test nodes in a test layer are determined that can detect the true value of a node predicted to be differentially affected by root causes. Some nodes are labeled as modifiable, and root node analysis is used to find potential modifiable nodes that can impact observed non-default value nodes.

### FIELD OF THE INVENTION

The present invention is directed to the field of artificial intelligence. More particularly, the present invention is directed to an improvement in the implementation of expert systems that can be used to improve computing performance and the quality and utility of analytical results through the use of test overlays, causation loops, and probabilistic determinations.

### SUMMARY

Prior art systems recognize at least two different models for representing expert knowledge. The first model, which can be considered a traditional expert system, use rules that establish relationships between nodes in a knowledgebase. The second model involves neural networks that use statistical analysis in order to identify or “learn” connections between items or nodes. Some experts refer only to rule-based systems as “expert systems,” although both rule-based knowledge systems and neural networks represent artificial intelligence approaches that are capable of providing expert advice to a problem given certain inputs about a situation. The present invention describes an improved method for implementing an artificial intelligence system using the more traditional expert system approach.

### BRIEF DESCRIPTION OF THE DRAWINGS

FIG. 1 is a schematic illustration showing the use of a computerized system to present diagnostic scenarios.

FIG. 2 is a schematic illustration showing the use of a computerized system to recommended treatments and predicted treatment effects.

FIG. 3 is a schematic illustration showing a sample knowledge repository.

FIG. 4 is an illustration of a user interface to the computerized system.

FIG. 5 is an illustration of a second user interface view to the computerized system.

FIG. 6 is a schematic illustration showing node values for three nodes.

FIG. 7 is a schematic illustration of two nodes joined by a connector.

FIG. 8 is a schematic illustration of three source nodes joined by connectors to one target node.

FIG. 9 is a schematic illustration of nodes joined by subtype connectors.

FIG. 10 is a schematic illustration of the impact of the connections shown in FIG. 9.

FIG. 11 is a schematic illustration of a test layer on top of the nodes and connections layer.

FIG. 12 is a schematic illustration of a user interface element showing details of a test.

FIG. 13 is a flow chart showing a method for determining a root cause.

FIG. 14 is a schematic illustration showing two potential diagnostic scenarios.

FIG. 15 is a flow chart showing a method for determining probabilities for scenarios.

FIG. 16 is a schematic illustration of study data used to determine root node probabilities.

FIG. 17 is a schematic illustration of a second sample knowledge repository containing a causative loop.

FIG. 18 is a schematic illustration of a scenario determined from the knowledge repository of FIG. 17.

FIG. 19 is a schematic illustration of a second scenario determined from the knowledge repository of FIG. 17.

FIG. 20 is a flow chart showing a method for determining test proposals.

FIG. 21 is a flow chart showing a method for determining treatment alternatives.

FIG. 22 is a schematic illustration of a user interface element showing proposed actions.

### DETAILED DESCRIPTION

### Overview

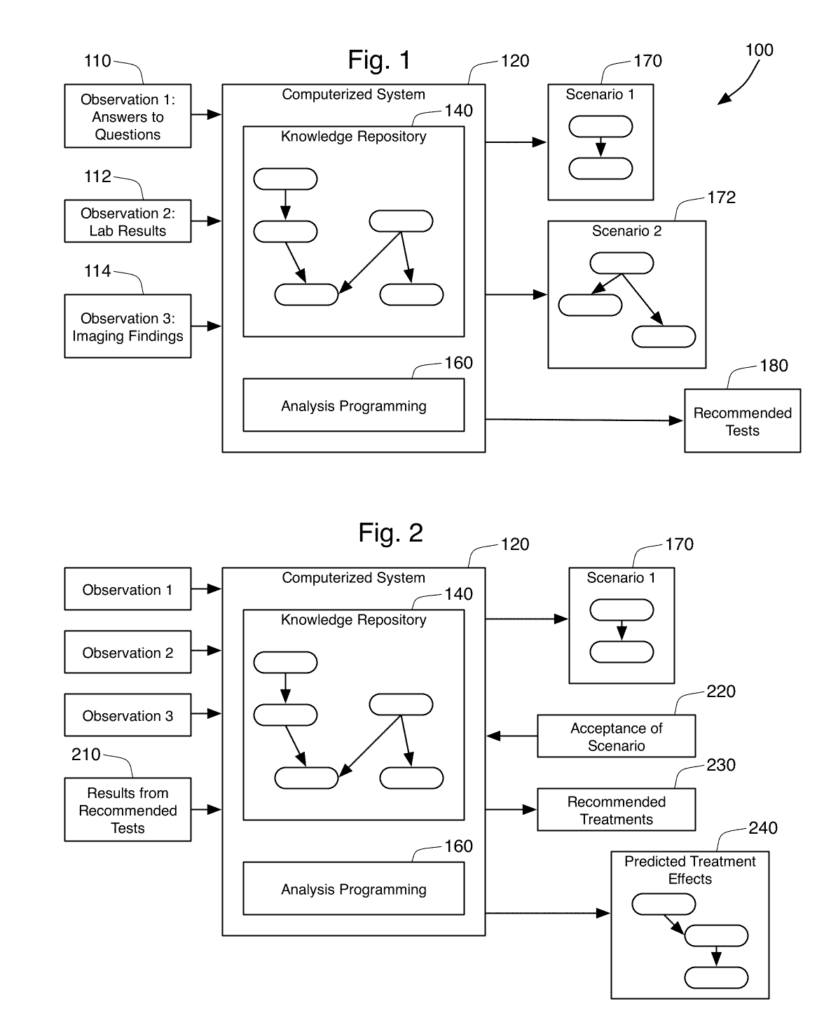

As shown in FIG. 1, a system 100 is presented that creates a probabilistic set of explanatory scenarios that connect known information together with predicted causes and effects to suggest tests, diagnoses, and treatments. FIG. 1 shows various inputs 110, 112, and 114 that are fed into a computerized system 120. To aid in the understanding of the present invention, one implementation of this invention is described in the context of a medical diagnostic, testing, and treatment recommendation system. As is clear from the following description, the techniques described herein can be utilized in a variety of disciplines. Assuming system 100 to be a medical system, the inputs 110-114 can take the form of medical observations, test results, symptoms, etc. For example, input 110 is a simple answer to a question that may have been asked to a patient. Input 112 is the results of lab work done for a patient, while input 114 represents findings from an imaging procedure performed on the patient.

The system 120 is a standard computer system, and may be operating as a stand-alone device or as a network server accessed over the Internet or other wide area network. Although it is not shown in FIG. 1, the computerized system 120 will include a general-purpose CPU such as those manufactured by Intel Corporation (Mountain View, Calif.) or Advanced Micro Devices, Inc. (Sunnyvale, Calif.). Memory on the system 120 will include a non-volatile, non-transitory, computer readable medium such as a hard drive or flash memory device, as well as faster but volatile RAM. Software instructions or programming can be found on the memory and are used to instruct the processor how to perform the methods of the present invention. As shown in FIG. 1, the memory on the system 120 will include both a knowledge repository 140 and analysis programming 160. The knowledge repository 140 includes the organization and structure of expert knowledge information, which are stored and organized in a manner that improves upon the organization and structure found in prior art expert systems. The analysis programming 160 relies upon this unique organization and its own internal processes to analyze the inputs 110, 112, and 114.

The system 120 uses the analysis programming 160 and knowledge repository 140 to analyze the inputs 110, 112, 114 in order to generate a visual set of potential explanatory scenarios 170, 172. These scenarios 170, 172 display relationships between known and predicted observations, and contain diagnoses that could explain the input findings as well as predicted effects of these diagnoses. Based on the predicted effects and the probabilities of the explanatory scenarios 170, 172, the computerized system 120 also generates a recommended set of tests 180 that is sorted based on the predicted utility of the results of those tests. A test in this case is defined as any action which gives you information such as a question, physical exam, lab test, or imaging test.

The physician will review these potential diagnostic scenarios 170, 172, and will be given an explanation as to why the recommended tests 180 will help distinguish between the presented scenarios 170, 172. After performing these tests 180 (or otherwise obtaining the information requested by the tests 180), the doctor can then add the test results 210 to the previous inputs 110, 122, 114 and have the system 120 re-run its analysis, as shown in FIG. 2. The system 120 will then generate a filtered list of explanatory scenarios that are consistent with the newly added test results 210. In FIG. 2, only the first scenario 170 remains consistent with these results 210, which means that only this scenario is output from the system 120. Once the doctor is content with this most likely diagnosis scenario 170, the physical can indicate that acceptance (represented by input 220 in FIG. 2), which will cause the computerized system 120 to present a list of recommended treatments 230 based on the accepted diagnostic scenario 170. The computerized system 120 also generates a prediction 240 showing the possible effects of these treatments, personalized based on what is known about the patient. All this information is provided to the doctor to consider when they make the ultimate decision about what treatment plan would be best for the patient. In some embodiments, potential treatments and tests are presented together to the user in the form of proposed actions to be taken.

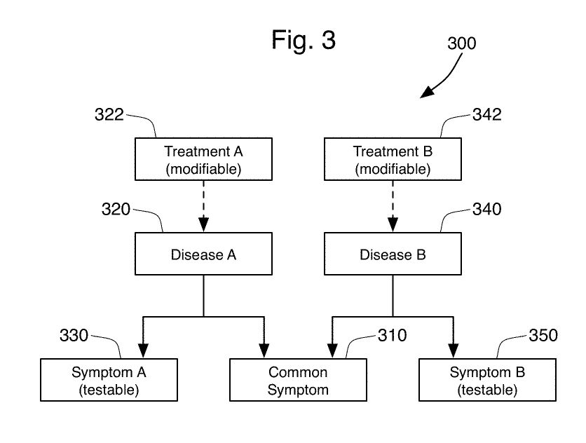

FIG. 3 shows a visual representation of a novel, computerized knowledge repository 300 of the type used by one embodiment of the present invention. The repository is shown schematically in FIG. 3 with a plurality of nodes related through a plurality of connections. This repository 300 contains information about two hypothetical diseases, A and B, which are represented in FIG. 3 as nodes 320 and 340. According to FIG. 3, the diseases 320, 340 are known to each cause one symptom unique to their disease (symptom A 330 and symptom B 350). In addition, these diseases 320, 340 both cause one shared symptom, namely common symptom 310. Connections from one node to another in FIG. 3 signifies that the source node (the base of the arrow connection) influences the target node (the end of the arrow connection). In this figure, a solid connector is an indicator that the source node has a positive effect on the target node. A dashed connector indicates that the source node has a negative impact on the target node. Two treatments 322, 342 are also included in the knowledge repository 300. Treatment A 322 is connected to disease A 320 with a dashed connector, indicating that the presence of treatment A 322 will have a negative impact on disease A 320. In other words, treatment A 322 lessens (or treats) disease A 320. Treatment B 342 likewise has a negative impact on disease B 344.

In FIG. 3, both treatments 322, 342 are tagged as “modifiable.” This indicates that it is possible for the physician to modify these values by applying the treatment to the patient. This would “modify” the value from being not present (the treatment has not been given) to being present (the treatment was applied). In addition, symptom A 330 and symptom B 350 are each tagged as “testable.” This indicates that a test is known to exist to determine the value of these symptoms/nodes 330, 350. As explained below, one embodiment of the present invention tracks testable nodes through the use of a second layer of test nodes, which would not require that individual nodes 330, 350 in the primary knowledge repository 300 be individually tagged as testable.

In this knowledge repository 300, both diseases 320, 340 are known to cause common symptom 310. If this common symptom 310 is observed alone, a doctor would not be certain which disease 320, 340 was responsible without doing further tests. When a doctor uses the computerized system 120, they can enter the fact that a patient is experiencing the common symptom. The analysis programming 160 will take this input and apply the information contained in the knowledge repository 300 to develop a set of compiled results similar to the two scenarios 170, 172 shown in FIG. 1, with each scenario representing one of the two diseases 320, 340 that may be responsible for the common symptom 310.

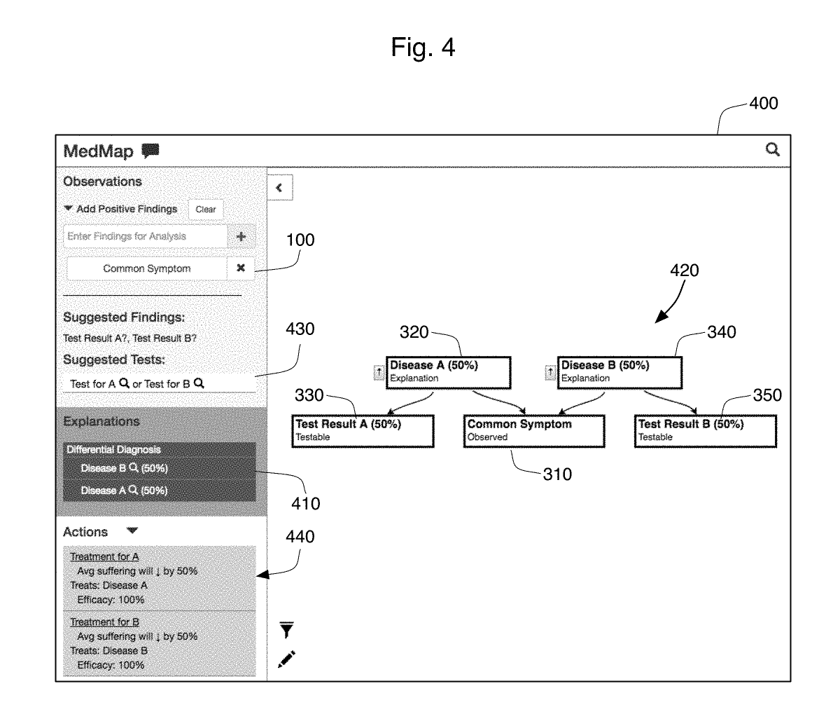

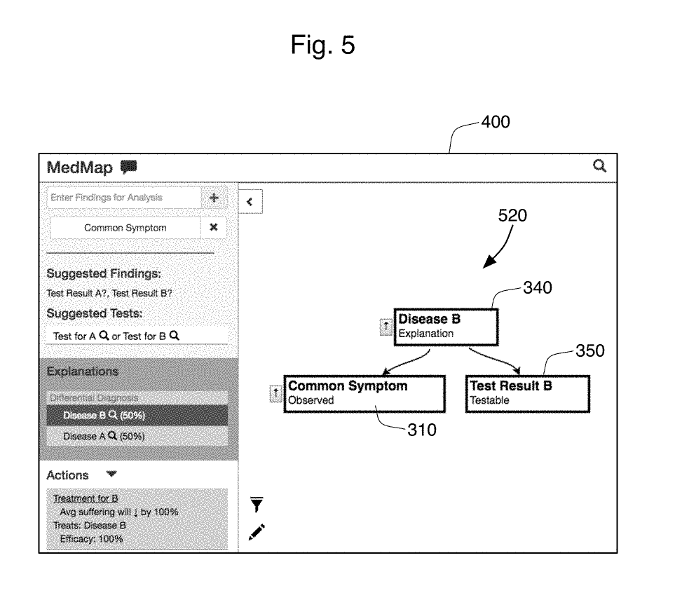

In one embodiment, the analysis programming 160 will display the scenarios using a user interface 400 similar to that shown in FIG. 4. The two explanatory scenarios matching the two possible diseases 320, 340 that could have caused the observed common symptom 310 are shown in the explanations area 410 on the left-hand column of the interface 400. In this example, the two diseases 320, 340 are encoded as being equally likely, so the analysis programming 160 determines that each has a 50% chance of being responsible. These two explanations are visually represented in the main portion 420 of the interface. In this embodiment, this visual representation shows a subset of the knowledge repository 300. The treatment nodes 322, 344 are not shown, as they are not of value in explaining the potential diagnostic scenarios. In addition, the testable symptom nodes 330, 350 are characterized as “test results” to emphasis that the presence of these symptoms 330, 350 are determinable through the use of some type of test. Furthermore, in the user interface 400 of FIG. 4, explanations are provided within the various nodes, such as explanations of the diseases represented by nodes 320, 340, the fact that common symptom 310 was the observed symptom, and the fact that separate symptoms 330, 350 are testable to help identify the correct diagnostic scenario.

Because the visual representation 420 of the relevant nodes and connections in the knowledge repository 300 may become quite complex, the analysis programming 160 gives a user the ability to select a single scenario for review, such as by selecting a single potential diagnosis in explanations area 410. For example, if the user were to select disease B as the diagnostic scenario to examine, interface 500 of FIG. 5 will be presented. In this interface, only the nodes and connectors relevant to disease B are presented in main portion 520. This presentation makes it easy to understand that if disease B 340 were the cause of common symptom 310, symptom B 350 would also be present and be testable by obtaining “test result B.”

Returning to FIG. 4, the left-hand portion of the interface 400 displays “Suggested Tests” 430, which recommends that the physician consider testing for Symptom A 330 or Symptom B 350. If one of these tests were run, such as the test for symptom A 330, the result would determine whether or not symptom A 330 were present in the patient. If symptom A 330 were present, then the symptoms actually present in the patient (namely symptoms 310, 330) would be explainable by the presence of Disease A 320 and not explainable by Disease B 340. Thus, Disease A 320 would be the only potential explanation presented in area 410. If the test determined that Symptom A 330 were not present, then Disease A 320 would not explain the presence of common symptom 310, because Disease A 320 would also cause symptom 330. Consequently, Disease B 340 would be the only remaining potential diagnosis that would explain the presence and absence of symptoms by the patient, and Disease B 340 would be the only explanation presented in area 410. Note that this example case ignores probabilities in the likelihood that a disease would cause a symptom. In other words, this simplified example case assumes that Disease A 320 always results in symptom 310 and 330 to be present. The addition of effect probabilities and root likelihoods into the knowledge repository 300 is described below.

The Actions section 440 of user interface 400 lists possible treatments based on the treatments 322, 342 embodied in the knowledge repository 300. In FIG. 4, each of the listed treatments is indicated to be 50% effective at resolving the current symptom 310 because there is only a 50% chance at this time that the treatment would be for the disease 320, 340 actually causing the symptom 310.

### The Structure of the Knowledge Repository 140

### Nodes

In one embodiment of the present invention, the fundamental unit in the knowledge repository 140 is a node, which represents a property in an inter-related set of properties that together represent a system. In the context of a medical expert system, each node represents a property in a system affecting a single human body. In this context, a node can represent such things as a medical abnormality, something measurable about the body like a concentration of a hormone in the body or a drug that is being administered, a symptom that the patient feels, a genetic mutation, trauma they have experienced, a bacteria that is infecting them, as well as the conceptual and physical intermediate nodes which represent how the value of one node is known to affect the value of another node. Each node in the knowledge repository 140 preferably has an id, a human readable name, a set of value possibilities which are assigned to a numerical range which together covers all real numbers, and a default value on that spectrum.

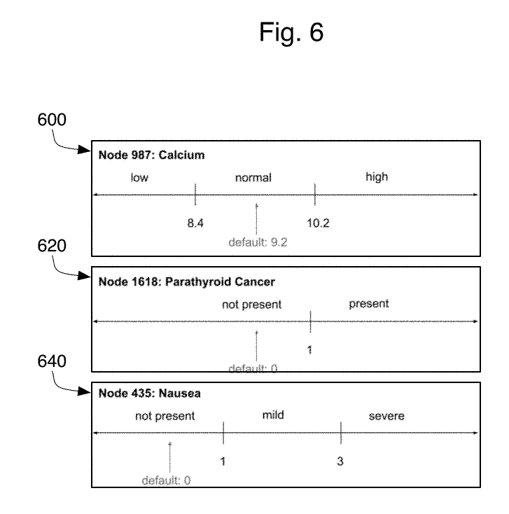

FIG. 6 shows three example nodes 600, 620, 640. Node 600 has an ID value of 987 and a human readable name of “Calcium.” Calcium levels can be measured in a patient's blood, and can generally be considered to have a “low” value, a “normal” value, and a “high” value. An assigned numerical value is indicated underneath, with the named, discrete values being determined from this numerical value. In FIG. 6, for instance, the division between a low discrete value and normal discrete value is at value 8.4, and the division between a normal and high value being at 10.2. The default numerical value is value 9.2. Similarly, node 620 represents parathyroid cancer, and can have only two discrete values: not present and present. Node 640 describes the nausea symptom, and is permitted to have three values: not present, mild, and severe.

It can be difficult to define a single node that will apply equally to all patients, as the values for a node may have different meanings based on things like a patient's age, gender, and ethnicity. For example, when interpreting the heart rate of an infant, what is considered normal would be considered very high for an adult. To allow for different node definitions that apply to different patients, one embodiment implements alternative or “conditional” node definitions. These constitute a list of node definitions that are defined in addition to the default node definition. Conditional node definitions are tied to a set of (id, value) conditions represented by other nodes, with the conditional node definition being selected and used only when these conditions are met. In the preferred embodiment, each conditional node definition has the same number of name ranges with the same names (such as the “low,” “normal,” and “high” ranges for the calcium node 600). However, the numbers defining the borders between the named value ranges can be different for each of the conditional nodes. In other embodiments, the borders between these values are not pre-determined, but are calculated during execution based on values of other nodes. It is important to ensure that conditional node definitions not form conditional dependency loops.

In addition to a node's required name and defined value ranges, nodes also have optional properties which describe their utility and are used when analyzing specific input into the system 100. These include the node's testability, modifiability, deleteriousness, and media annotations. Each of these is described in more detail below.

To enable the present invention to recommend tests in area 430 of interface 400, the analysis programming 160 has to know which predicted node values are testable by the doctor, and which tests allow the doctor to observe those node values. To accomplish this, tests are defined as separate entities distinct from standard nodes, as is described in more detail below. These tests identify which nodes they are capable of detecting/observing. By indicating that a node can be observed by a possible test, the node is thereby indicated to be testable. A node is considered testable if there is a test defined that, once the test is performed, the value of the node would be known.

To enable the present invention to suggest ways that the doctor can influence the values of nodes, nodes can be declared to have modifiable values. These modifiable nodes may take the form of treatments that can be applied to a patient. In the case of a drug treatment, the node is declared to be modifiable, and in fact can be declared to be modified to be at a variety of doses, or modified to be stopped completely. A node representing whether the patient has had a specific surgery however, can only be modified to go from the surgery not having been performed to having been performed, and therefore this node modification is generally considered irreversible. Surgeries and some treatments can be re-performed, and this can be handled by either using a node representing a “history of a surgery” to represent the effect of that prior surgery, or by using time-based connections to simulate the effect of multiple node value changes over time. Nodes representing other things besides drugs and surgeries are modifiable as well, such as lifestyle changes and diets, which can be modified to exclude or include certain elements.

To enable the analysis programming 160 to be able to evaluate the value of actions such as suggesting a treatment (a change in a modifiable node value) or a test that can lead to information needed to make a better suggested diagnosis or treatment, the programming 160 has to understand what node values in scenarios are ultimately more desirable or less deleterious than others. Ultimately, the path that is best for a given patient depends on the personal values of that patient, but there is some consensus on some side effects being largely worse than others in society and defaults for the deleteriousness of node values can be encoded to guide suggestions and then personalized as needed. This is also true when the system is analyzing non-medical systems. One implementation is to encode these as values between 0 and 100 on a relative deleteriousness/badness scale, and the overall deleteriousness of a scenario can be a sum of the deleteriousness of the node values it is made predicted to include. Another implementation is to encode relative node value deleteriousness collected by comparison surveys of value pairs with relative probabilities. These relative values can be converted to absolute values for a scenario set by finding the value which is rated to be the worst relatively, assigning it 100, and calculating the others relative to it to be appropriate fraction of 100.

In additional to functional optional properties described above, the nodes in the knowledge repository 140 also are able to incorporate media annotations for the node. Media annotations can consist of one or more images, videos, web links, or written text descriptions about the node. These media annotations can be used for searching for nodes, or can be presented to the user for educational purposes about the node.

### Connections

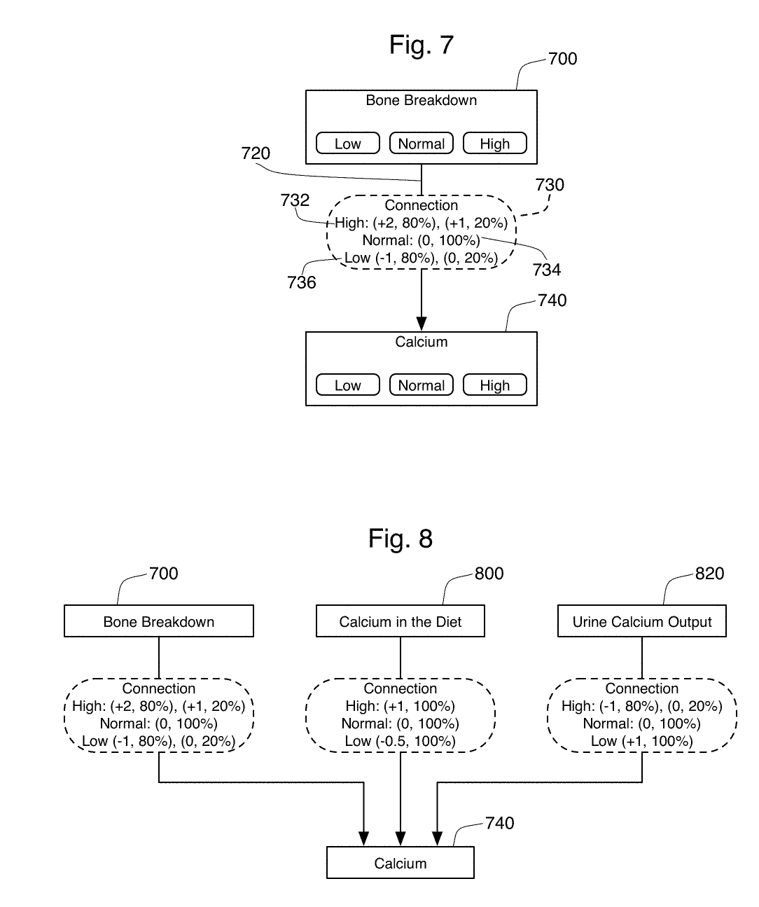

The nodes in the knowledge repository 140 are connected together through connection definitions. These connections do more than link the nodes, they also define the manner in which one node has an effect on the value of the connected node. FIG. 7 shows an example connection 720 that links a source node 700 with a target node 740. In one embodiment, the connector 720 is represented in the knowledge repository 140 as a data element having a source node id (that identifies source node 700), a target node id (that identifies target node 740), and impact data 730 that indicates how the value of the source node 700 impacts that target node 740. In the embodiment shown in FIG. 7, the impact data 730 is defined by data pairs that are defined for each of the potential range values of the source node 700. In FIG. 7, the source node 700 for “bone breakdown” indicates that this node 700 can have a low, normal, or high value. Consequently, impact data 730 contains information defining how each of these values separately impacts the target node 740, which indicates calcium level in the body. FIG. 7 shows these pairs as (delta, probability) pairs, with the first number being the delta or change that will be made on the value in the target node 740, and the second value indicating the probability that this will be the impact on the target node. For the high value of the bone breakdown node 700, two data pairs are present, namely (+2, 80%) and (+1, 20%). Each of these pairs has a separate probability value, but the total probability of the data pairs adds up to 100%. These two pairs indicates that a high value in the bone breakdown node 700 has an 80% chance of causing a +2 increase in the value of calcium node 740, and a 20% chance of causing a +1 increase. Likewise, FIG. 7 indicates that a normal value has a 100% chance of causing no change (0) in the calcium level. A low amount of bone breakdown in node 700 has an 80% chance of causing a −1 decrease in the value at the calcium node 740, and a 20% chance of causing no change.

FIG. 8 shows that multiple source nodes 700, 800, 820 can be connected to a single target node 740, with each source node 700, 800, 820 having the ability to affect a change in the value of the target node 740. In this case, the ultimate impact on the value of the target node 740 will be the sum of the delta effects from the source affecting nodes. Affecting deltas may constructively sum to a high absolute net delta, or competitively counteract the effects of each other with a combination of positive or negative deltas. In FIG. 8, bone breakdown 700 has the affects described above in connection with FIG. 7. Similarly, high Calcium in the diet (node 800) increases calcium levels independently, and low dietary calcium has a negative effect. Urine output of calcium (node 820) being high reduces the calcium in the body (negative value effect), but when urine calcium output is low, the blood calcium is expected to increase. These sources act independently and their effects sum together to create a net effect on the value of Calcium in the body (target node 740). In one embodiment, the combined delta will be summed with the default value for the target node 740, thereby creating a new value for that node 740. The idea of this schema is to represent that a person at one period of time may have a baseline value in one node, but other things can add or subtract collectively to that value in a way that is represented quantitatively, which can tip the value into a different range, and subsequently cause a trickle effect onto other node values depending on that change in value.

In some situations, the effect of a node on another node is different between people based on demographic information such as their age, gender, or ethnicity, so in addition to having a default definition, connections can also have multiple conditional definitions. Conditional connection definitions simply have a set of (node id, value) pairs which must be satisfied before this definition is used in place of the original set. For example, a conditional connection definition might apply only if the age node has a value of less than 1 years old. The definitions are ordered in such a way that going down the list, if any set of conditions is met, that definition is used, and if no set of conditions is met, then the default definition is used. Conditional connection definitions are required to be designed to not form conditional dependency loops. This problem of needing to alter definitions based on demographic information of the patient, and the solution of using conditional definitions, is similar to that described above in connection with conditional node definitions.

In cases where conditional definitions aren't sufficient to represent a connection, or when the numerical delta depends on the specific numerical value of the source, not just the named range it is in, then a code-based definition can be written. This code-based connection definition declares which nodes it depends on in addition to the source, and is given the values of those nodes and the source upon code execution, and returns a set of (delta, probability) effects with probabilities adding to 100%.

A person is modeled as having values for every one of their nodes at each point in time, and the way that nodes have delayed impacts is represented through a set of time-based connection definitions. Time-based connections are just like the normal connection mappings of source values to probability distributions of delta effects, but each time-based definition connection has a time value and probability of the overall time-based connection. This can be a fixed representation or also be generated with a code-based definition to be conditional.

### Node Subtypes Using Subtype Connectors

Nodes may be declared to be a subtype of another node. There are many situations where different nodes have similar frameworks for their required subtypes. One example is Left/Right redundancy such as when a hand abnormality can happen on either the left or right side or both, like with many other of the bodies symmetrical systems. Another example is resistance genes, which can enable many bacterial infections to have subtypes that are resistant or not resistant to given medications. In some embodiments, subtype nodes (“subnodes”) are connected to their parent supertype node (“supernode”) through a special type of node connector that is known as the subtype connector.

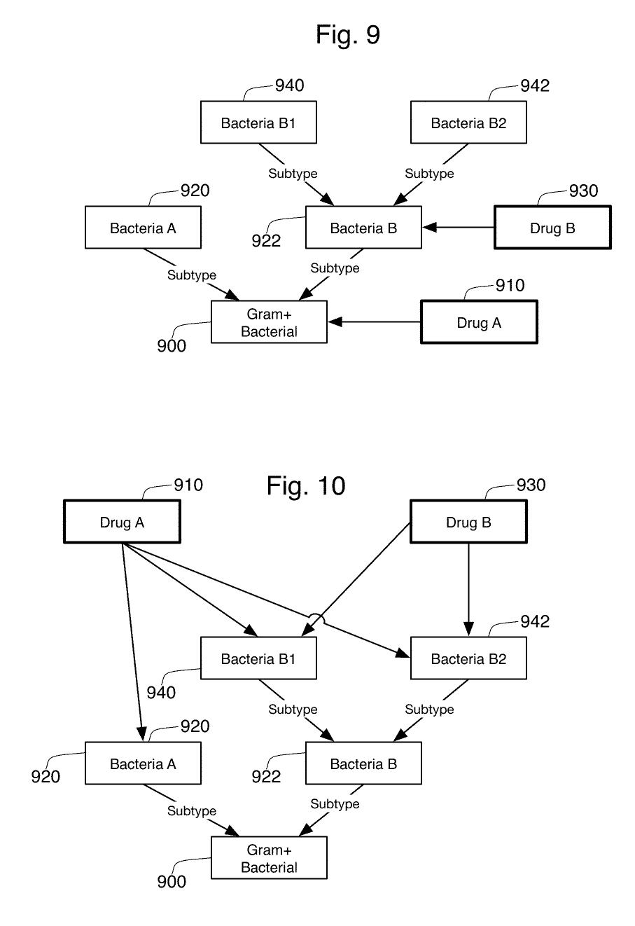

Often, in practice, a medical node has a similar effect on everything within a class of nodes, such as when an antibiotic being present can have a negative delta effect on any bacteria of a certain bacterial class. In order to prevent messy and difficult to maintain duplication of connections between a drug and every bacteria in the class, nodes were able to be declared to be subtypes of other nodes and be affected by everything which affects the supertype node. In FIG. 9, the Gram+ Bacterial node 900 is the supertype of two bacterial nodes, namely Bacteria A 920 and Bacteria B 922. These nodes 920, 922 are the subtypes of supernode 900. The node 922 for Bacteria B is also a supertype node to Bacteria B1 node 940 and Bacteria B2 node 942. In one embodiment, the relationship between subnodes and supertype nodes is established in the knowledge repository 140 using connectors that have a property that declares the connection source as being a subtype of the target node. Thus the connectors in FIG. 9 indicate that nodes 920 and 922 are subtypes of node 900, and nodes 940 and 942 are subtypes of node 922.

Once a node has a connection to it which declares that it's source is a subtype (e.g., the target node is a supertype of the source node), then any connections to that supertype are interpreted as being redirected to each of the connected subnodes instead. For example, drug A 910 is known to have a negative impact (it kills) all bacteria of supertype 900, and drug B 930 is known to have a similar impact on supertype 922. While this is shown with a direct connection to the supertype 900, 922, the actual interpretation redirects these connections to the subnodes. FIG. 10 shows how one embodiment of this redirection interpretation would play out in the configuration of nodes shown in FIG. 9. Thus, drug A 910 is considered to have a direct impact on Bacteria A 920. Because there are multiple levels of subtypes in FIG. 9, connections to any node are recursively redirected to apply to all subtypes of their original targets. As a result, Drug A 910 is considered to have an impact on Bacteria B1 940 and B2 942. Similarly, Drug B 930 also has an impact on Bacteria B1 940 and B2 942. If a loop of subtype declarations is erroneously made, then the recursion avoids redirecting connections to nodes it has already been redirected from. If an additional connection is defined from the source of a connection directly to a subtype of the target of a given connection, then that connection is given priority and the current connection will not be redirected to that subtype. Once a supernode is referenced as having subtypes, then the only way to affect its value is through the connections that describe how subtypes affect their supertype.

In cases where a node has an effect on all subtypes of another node, but has slightly different probabilities of doing so to certain subtypes, a bias percent (between 0-100%) can be declared in a connection with regards to a (delta, probability) pair which multiplicatively reduces the probability when the connection is applied to specific subtypes. In order to maintain the full probability distribution adds up to 100%, it also adds another pair with a zero delta and enough probability to sum up to 100%. The same effect as interpreted biased connections can also be done by creating individual connections to each subtype with custom probabilities, but in practice, biased connections to supertypes is a useful construct.

Because these subtypes are common to many nodes, an optional property of a supertype node can be to require that its subtype nodes relate to and represent specific instances of a defined dimension, such as a laterality dimension that requires subtypes that represent the left and right possibilities, or a methicillin resistance dimension that requires subtypes that represent the possibilities of resistant and sensitive. These subtype nodes represent a specific subtype on the defined dimension. If a supertype node is found to be lacking a subtype node for each of the possibilities on the dimension, then the computerized system 120 will automatically generate the missing subtype nodes and create connections from them to the supertype. This automatic creation of subtypes also enhances the inherent ability of biased drug connections to supertypes to be able to be defined as only affecting subtypes that are declared as sensitive to the drug.

### Tests

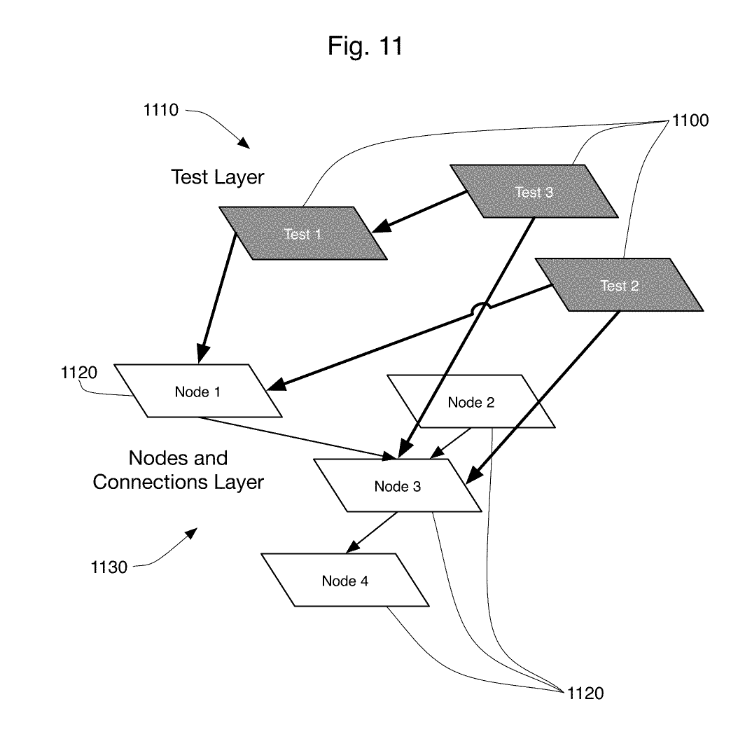

In addition to a set of node and connection definitions, the knowledge repository 140 contains a set of defined tests 1100 as shown in FIG. 11. The term test is used broadly to encompass any action which reveals the value of a patient's node, and it can include asking the patient a question, running a physical blood test, taking and analyzing a medical image of the patient, etc. These tests 1100 are primarily defined by a list of the ids of the nodes 1120 that would be observed when the test is done by a doctor. In FIG. 11, the tests 1100 are conceptually represented as existing on a test layer 1110, which sits above the nodes and connection layer 1130. Tests 1100 are defined as a separate layer 1110 from the nodes and connections layer 1130 because they serve to annotate the node 1120. One test 1100 may disclose the values of many nodes 1120. For example, a chemistry panel would inform a physician about the levels of Sodium, Potassium, Chloride, Bicarbonate, Creatinine, Glucose, and Calcium in the body. Similarly, a Musculoskeletal Physical Exam will inform about a variety of different muscle strengths and ranges of motion. Appropriate suggestions for test 1100 that can rule out diagnostic scenarios are identified and ranked in order of value using the method described below. Multiple different tests 1100 may reveal information about the same nodes 1120, such as a specific test of a given gene mutation and a general test of a whole genome. Tests 1100 may also contain a list of other tests which they fully include, which is interpreted as adding recursively all sub-test observed nodes 1120 to the list of nodes 1120 observed by the current test 1100.

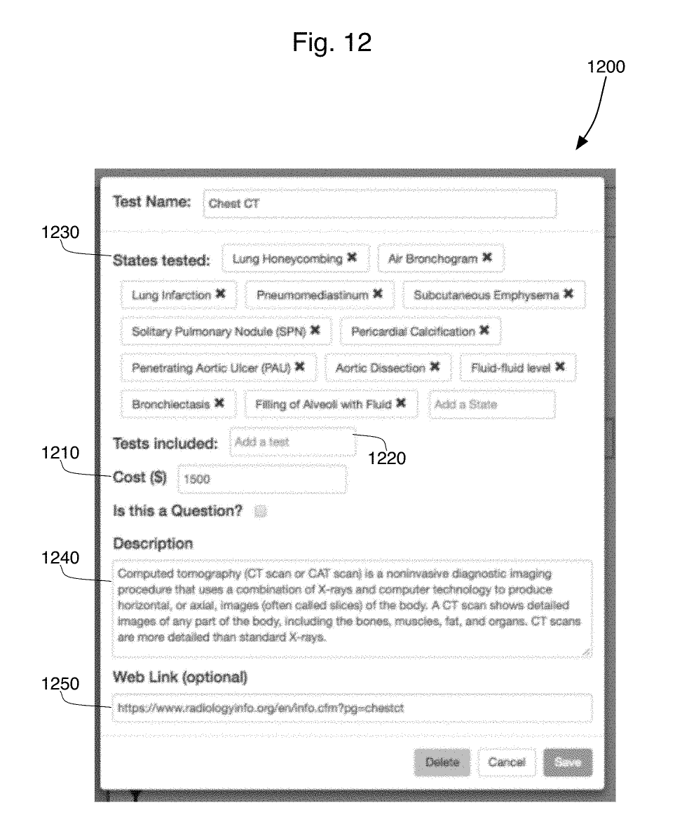

FIG. 12 shows the type of test data 1200 that can be maintained for each test 1100 in a knowledge repository 140. One of the most important elements of test data 1200 is an absolute measure of the test's cost 1210 in dollars or a relative measure of their cost on a scale such as 1 to 100 for purposes of comparison, in order to assist in suggesting cost-effective tests 1100. The subtests 1220 as shown, as well as the nodes/states 1230 that will be determined by running the test 1100. This data 1200 will also describe the test in description 1240, and may include links 1250 to additional information. It can also be useful to include the time it takes to complete the test 1100, which can be a crucial factor with regards to whether a test 1100 is useful in a critical condition where a delay in treatment can increase morbidity. Additionally, tests 1100 can include a set of node value modifications that will be expected to happen as a result of the test 1100, such as an injection of contrast material, a hormone stimulation trial, or a period of time in a tight space, which can be useful to know when a patient has a known allergy or adverse reaction to such things.

### Method for Detecting Root Cause Sets

As shown in FIG. 1, the analysis programming 160 of the computerized system 120 uses the knowledge repository 140 to provide guidance on a particular factual situation. In most applications, the computerized system 120 will present a user with a user interface that allows the user to provide non-default values for selected nodes in the knowledge repository 140. The user can also input known values that are equivalent to the default value, as such knowledge about a node may be important in dismissing otherwise possible diagnostic scenarios. The analysis programming 160 then uses its programming and the knowledge repository 140 to infer possible sets of other node values that may have been the cause for these non-default values. In particular, the system 120 is designed to find potential root causes for the non-default node values. These non-default values may ultimately all be the result of one root abnormality, or, as is often the case, multiple root causes. A root cause is a node value that cannot be explained by values of any node that has a connection directed toward it, or simply has no nodes connecting toward it.

In the context of a medically-oriented knowledge repository 140, the analysis programming 160 would accept symptoms (known, non-default values for particular nodes) for a patient, and then provide possible scenarios that would explain the presence of these symptoms in the patient. Most symptoms (or patient findings) a doctor may enter will be caused by internal physiological abnormalities that are unseen to the doctor. Examples of root causes in the medical context include genetic mutations, bacterial infections, drugs, trauma, and spontaneous pathologies which have no known cause yet. For a set of abnormal findings (specified non-default node values), there could be many different sets of root causes that have a chain of connections which could be expected to cause the nodes in the findings to go from their default values to the observed values.

The technique used to determine the set of possible root causes can be broken down into one core method that is applied recursively. This method can be thought of as “what causes this?” The knowledge repository 140 is analyzed to examine if source or parent nodes could have caused the value found in the node being analyzed. When effects of connections from two sources are required to explain why a given node has a value, then each source value is attempted to be explained individually, one at a time, before going back and searching for combinations of source node values that can explain the finding. Next, each of the possible source node values that could explain the finding's value are analyzed individually using the same “what causes this?” method to determine a set of its root source node values that could explain its deviation from normal.

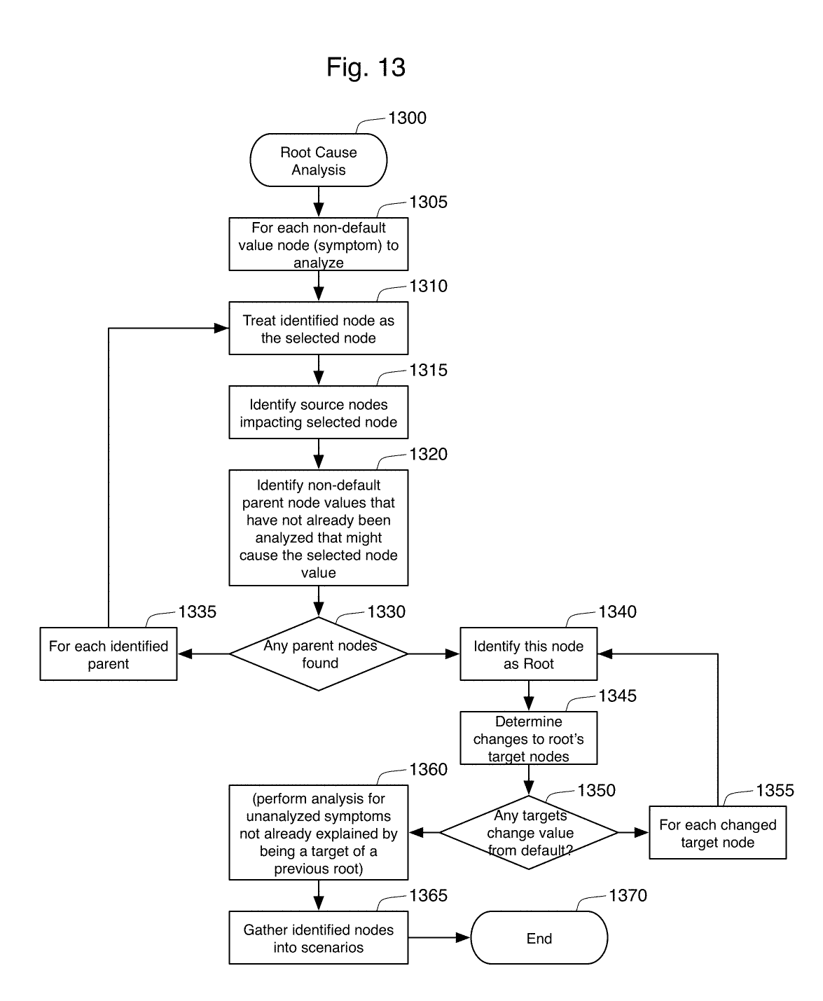

FIG. 13 shows a method 1300 that finds these root cause nodes. The method 1300 starts with identifying one or more findings or symptoms to be analyzed in step 1305. The findings that are selected at this step are effectively nodes that have been identified by the user of computerized system 120 as having a value that is something other than the node's default value. In one embodiment, the analysis programming 160 will provide a user interface to allow the user (such as a doctor) to input the non-default values for particular nodes. In the context of the partial knowledge repository 300 shown in FIG. 3, for instance, the node with the non-default value to be analyzed would be common symptom node 310.

Because multiple non-default nodes might need to be analyzed, step 1305 makes sure the following steps occur for each of these nodes. Step 1310 explicitly selects a single one of these nodes to be the selected node for analysis, in some implementations this is the most rare abnormality. Step 1315 then identifies all of the nodes that have connections with the selected node. In particular, step 1315 identifies the source nodes having connections where the target of the connection is the selected node.

These source (or “parent”) nodes have the ability to alter the value of the selected node through these connections. As explained above, each connection defines the impact of the source node on the target node, and this impact will vary depending on the value of the source node itself. The range of possible, non-default values for each of these source nodes is therefore analyzed in step 1320 to determine if one or more, or even a combination of these source nodes, could cause the known, non-default value of the selected node. If single source node, or a combination of source nodes, are determined to be capable of causing this known value, these nodes and their required values (the node value that is required in order for the source node to have the appropriate impact on the selected node) are identified.

At step 1330, the result of step 1325 is considered. If potential causative source nodes have been identified, then step 1335 causes each of these nodes and their required value to be analyzed according to steps 1310-1330. Programmers will understand that this type of call within a method can be considered a recursive algorithm. In other words, if the analysis of the first symptom identified in step 1305 indicated that one of the parent nodes might be capable of causing the symptom node value when the parent node had a particular value, this parent node will be analyzed with this particular value as the selected node in step 1310 to determine if the parent node itself has any source nodes (grandparents to the original non-default value node) that could cause the particular value in the parent node. If a parent node has previously been analyzed, to explain another finding, then it is not considered to have any other possible value than the value explored initially, so as to not invalidate the causal pathway in the initial finding analysis. As explained below, this aspect of the present invention allows for the system to correctly analyze connection loops.

The recursion stops if step 1330 determines that there aren't any parent nodes to the currently selected node, or if step 1330 determines that none of the parent nodes, acting alone or in combination, could cause the known value of the selected node. If this is true, then this node is identified as a root node at step 1340. This root node and its associated value is considered a possible “root cause” of the originally evaluated non-default value node. Before going on to look for root causes of other node values that have not yet been considered, the root cause and its associated value from step 1340 first goes through an “effect propagation” process. Effect propagation involves an algorithm (steps 1345-1355) that examines connections going from the root node (the source of the connection is the root node) out to other nodes, and analyzes the impact that the root node's associated value will have on each of its target nodes. This occurs at step 1345. Step 1350 then determines if the effects from the root node are enough to cause to cause any of the target nodes to have new values. If so, then each of these altered value target nodes are selected at step 1355 and are subjected to the same effect propagation process (although these child nodes would not be considered root cause nodes). This propagation continues until no more nodes are affected. It is valuable to do this effect propagation process when a possible root cause is found, because some of these propagated effects could end up propagating down to explain the other findings that were given initially.

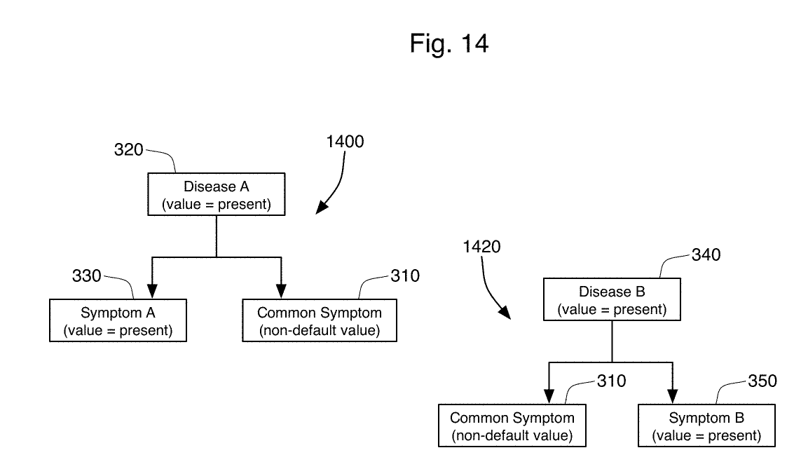

When the effect propagation process is completed and no more target nodes with changed values are identified at step 1350, the method continues at step 1360. This step simply indicates that the process must be continued for any unanalyzed parent nodes (from step 1335) or any unanalyzed, originally identified non-default value nodes (from step 1305). When all nodes have been identified, step 1365 will gather the identified nodes (from steps 1325 and 1345) into list of possible causative scenarios, complete with root cause node values and the expected effects of those root causes. Returning to FIG. 3, an analysis using method 1300 for common symptom (or non-default value node) 310 will identify two potential root cause nodes, namely Disease A 320 and Disease B 340, which will result in two separate scenarios 1400, 1420, as shown in FIG. 14. Scenario 1400 identifies node 320 as one potential root cause node, with the value of the node being “present.” This value indicates that node 320 is a potential root cause when the value of the node indicates that Disease A is present. Note that the value of the node 320 may be more than a binary (present or non-present). For instance, the value of node 320 could indicate the severity of the Disease A. It may be that Disease A would only cause the non-default value of the common symptom 310 if the severity of the disease were “severe” and would be incapable of causing this value in symptom 310 if the disease state were “mild.” The effect propagation process performed when node 320 was identified as a potential root cause node will have identified that the presence of Disease A 320 will also result in Symptom A 330 having a non-default value, which is why this node 330 is presented as part of this first scenario 1400. Method 1300 would also have identified node 340 as a potential root cause node when the value of the node 340 indicated that Disease B was present. Effect propagation would have identified that the presence of Disease B will also cause Symptom B node 350 to have a value other than its default. Thus, the second scenario 1420 shows how the common symptom 310 could be caused by the presence of disease B 340, which would also result in Symptom B 350 having a value other than its default.

In some embodiments, it is possible to analyze findings over multiple encounters. When findings/symptoms are entered, they can be tagged with specific times and dates. This time information can then be used to search for potential root causes using method 1300. Because node connections can have time-based effects, node values in findings can evaluate whether connections from source values in the past can explain their current values, and effects can be propagated into the future. The scenarios from a search which includes nodes with time-specific values would have a set of node-values for multiple times including the times of the node values given in the findings.

Once a set of scenarios is found, these scenarios can sometimes be grouped together. Groupings are accomplished by identifying commonalities in node values in each scenario. A grouping algorithm finds sets of scenarios with the most nodes in common, and each set can be replaced with a scenario which only contains the nodes in common among the set. The multiple scenarios that share these common nodes can presented to the user as a single collapsed scenario, which can be expanded back into the original set visually on demand.

### Scenario Probabilities

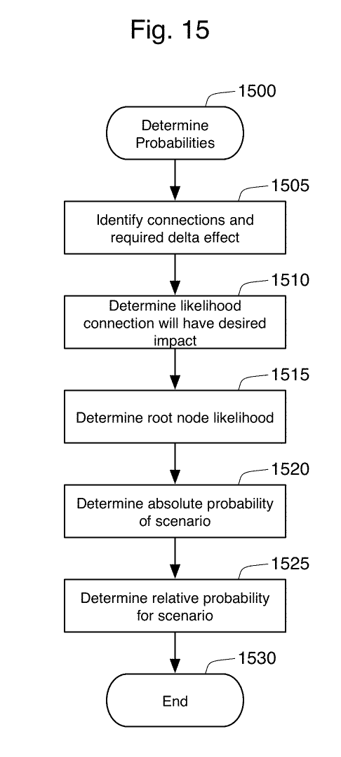

After a complete set of explanatory scenarios are produced, the probabilities for the scenarios are determined. This is accomplished using the method 1500 shown in FIG. 15. Scenario group probabilities are the sum of the probabilities in their original scenarios. The following descriptions will refer only to single scenarios in order to simplify the explanation. The first step is to identify each of the connections in the scenario and the required delta effect, which is step 1505. For each of these connection values, step 1510 determines the percentage likelihood that a given value of a node will have the necessary impact on a target node required for the scenario. As described above in connection with FIG. 7, a given node value have a range of impacts on the target value based on the data pairs that are defined for a particular value of a source node. In FIG. 7, a high value of the bone breakdown node 700 has an 80% chance of impacting the value of the calcium node 740 by +2, and a 20% chance of impacting the value of the calcium node +1. The scenario being evaluated may require that the calcium value increase by +2 in order for the symptom to be identified. Thus, there is only an 80% chance that the high value of node 700 will have the necessary impact on the target node 740 for the scenario to occur. This 80% value is the value determined at step 1510 for this connection. This step 1510 determines this value for all of the connections in the scenario.

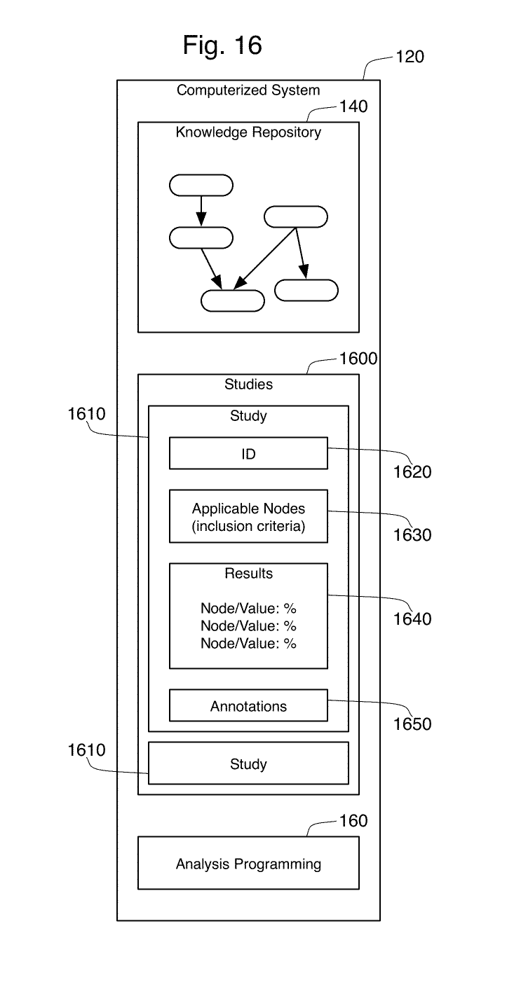

Next, step 1515 determines the probability that the scenario's root nodes will have the necessary values to cause the impact required by the scenario. Returning to FIG. 7, a scenario may determine that the bone breakdown node 700 is the root cause node of the scenario. In the scenario, this root node 700 must impact its target node 740 by increasing the value of the target node 740 by +2. The only manner in which this can occur is for the root node 700 to have a “high” value. Step 1515 determines the probability that the root node 700 will have the value required for the scenario to occur. This is known as the root cause value probability. For scenarios having multiple root causes, the root cause value probability needs to be calculated for each root. In one embodiment, root cause value probabilities are derived from a structured database of “studies” 1600 that is stored alongside the knowledge repository 140, as shown in FIG. 16. The studies database 1600 contains data reflecting research trials, and can be used both for determining root cause node value probabilities as well as for validating the predictions made by the knowledge repository 140. The database 1600 can be considered to contain a plurality of database entities that are each known as a study 1610. Each study 1610 has its own unique id 1620, a set of inclusion criteria node values 1630 that describe features of the population that were studied, and a set of study results 1640 given as probabilities of this population having certain other node values. In the medical environment, the applicable node values 1630 can represent demographic data that identify those individuals analyzed in the study. Note that it is acceptable for a study to apply equally to all individuals. In other contexts, the inclusion criteria node values 1630 would continue to represent factors that identify a subset of the items being analyzed. For instance, if the knowledge repository 140 related to identifying root causes in airplane defects, the inclusion criteria 1630 might identify engine manufacturers or particular engine models that were analyzed in the study. Annotations 1650 with sources and written descriptions are also included in the study data. These studies 1610 are used to determine root cause probabilities, by searching for a study 1610 that has the closest match of applicable nodes 1630 given the rest of the scenario node values (e.g., studies that best represent the demographics of the patient being analyzed), and also has study results 1640 that refer to the probability of the root cause node value. If no study exists to describe the root cause value probability, a very small default rare likelihood is used.

Once the root cause value probability is determined, step 1520 can determine an absolute probability for the scenario by multiplying the probability of the root cause value probabilities (determined in step 1515) against each of the probabilities that the connections will have the necessary impact along the path defined by the scenario (as determined in step 1510). Because any causal dependence is already captured in the network structure, the root cause chances and connection path chances are assumed to be independent, thus the absolute chance of the whole scenario existing is the product of the chances of all of the root cause values and the chances of each connection path. Note that it is not necessary to consult the studies database 1600 to determine the likelihood of any intermediate node having its determined value because the intermediate node values are completely determined by the value of their parent nodes and the impact of the connections coming from those parent nodes.

At step 1525, each individual scenario and group is assigned a relative probability based on the sum of the absolute probabilities of the scenario or set of scenarios represented by a group divided by the total absolute probability of every scenario in the set. For example, a set of three scenarios to be presented may have only a net absolute probability of 2%, with a first scenario having an absolute probability of 0.1%, a second scenario having an absolute probability of 0.4%, and the third scenario have an absolute probability of 1.5%. Step 1525 will assign a 5% relative probability to the first scenario, a 20% relative probability to the second scenario, and a 75% probability to the third scenario. Finally, step 1530 compares the relative probability of each scenario to a threshold that is used to decide whether scenarios should be displayed to a user. If the relative probability of the scenario or scenario group is over the threshold, then it will be displayed. The method 1500 of determining the probabilities for a scenario then ends at 1530. In some embodiments, if individual scenarios have an insufficient chance of occurring, then the scenarios can be presented in a scenario group that has a greater summative chance over the threshold.

### Connection Loops

An important feature of method 1300 is that it able to search through knowledge repository 140 that includes directional connections that chain together to form loops. Feedback loops are very common in medicine and often involve a source node that not only has a positive impact on a node's value, but is negatively affected by the value of the target through another connection. In nature this is a mechanism which keeps levels of hormones, chemicals, and enzyme activities at an appropriate level.

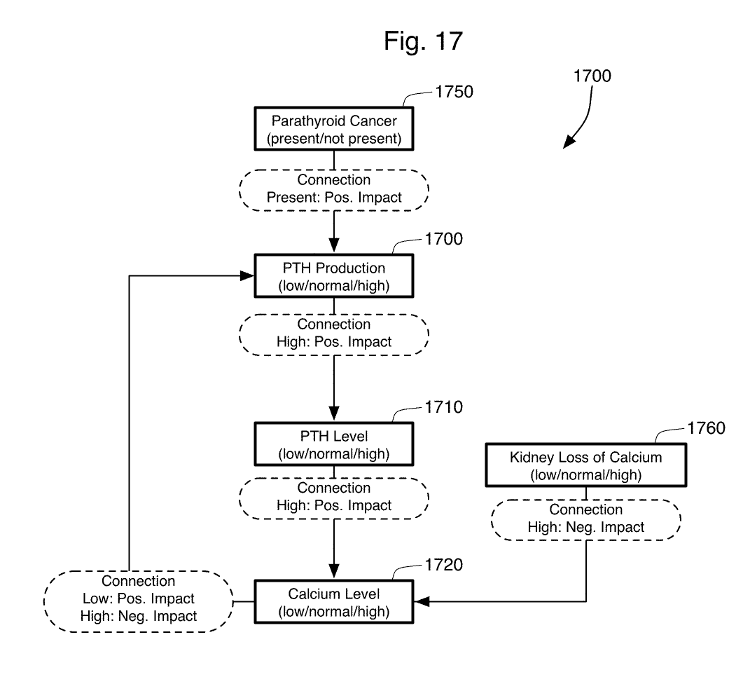

An example is shown in the partial knowledge repository 1705 shown in FIG. 17. This knowledge repository 1705 shows that there is a hormone called PTH (Parathyroid Hormone) that is produced when a person's Calcium is low. PTH is thought to be the body's signal to increase Calcium levels. Thus, node 1700 relates to PTH production, and it has potential values of low, normal, and high. Similarly, there is a node 1720 that represents calcium level, which can also have a low, normal, and high value. The calcium level node 1720 is connected with the PTH product node 1700. When the calcium level 1720 is low, this connection will increase PTH product in node 1700, and when calcium level is high the connection will reduce PTH product in node 1700. When PTH production is high in 1700, this will increase the PTH level in the person, represented by node 1710. An increase in the PTH level 1710 to a high level will have a positive impact on the person's calcium level 1720, thus having an effect of causing the body to increase the calcium in the blood. This looping, feedback system is known as a connection loop in the knowledge repository 1705. In a healthy person, PTH production 1700 is in a normal range, PTH levels 1710 are normal, and so is Calcium 1720.

Knowledge repository 1705 also indicates that the presence of parathyroid cancer (node 1750) will cause PTH production 1700 to increase, which will increase PTH level 1710. Similarly, if something disrupts the kidneys and the kidneys have a high loss of calcium, this will cause the calcium level 1720 to decrease, PTH production 1700 will respond by going up (because the calcium level 1720 affects PTH production 1700), and the body will have a high level of PTH 1710. If the body were functioning properly, the loop in the knowledge repository 1705 would eventual bring the PTH and Calcium levels 1710 back to normal, but these causes may prevent this from happening.

If the analysis programming 160 were presented with a symptom that indicated that the PTH was measured and found to be high, it would analyze the knowledge repository 1705 using method 1300 to determine the possible root causes for this symptom. Unlike many other expert systems, the analysis programming 160 programming can process this loop in causation and still present two different potential root causes 1750, 1760. This is possible because the analysis programming 160 operating method 1300 considers the nodes being analyzed to be in a steady state. The method 1300 will iteratively analyze source node values, but as it does so it maintains a record of the values of all nodes previously analyzed that connected the node being analyzed to the original finding. When the analysis of parent nodes returns the method 1300 to a node that it has previously analyzed, the method only considers scenarios where node values do not change from what was previously chosen to be explored.

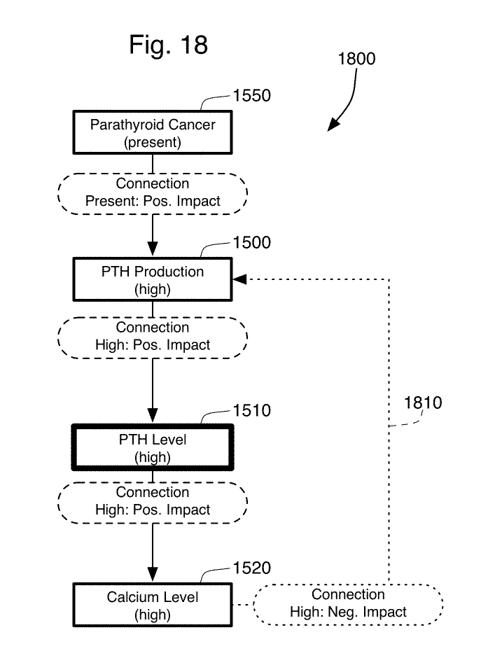

For example, FIG. 18 shows the created scenario 1800 in which parathryoid cancer 1750 was considered to be a potential root cause for the symptom of PTH production 1700 being high. As the method 1300 considered parent nodes that could cause this value, it eventually reached node 1750. During effect propagation, it would reaffirm a high value of PTH production 1700 and a high PTH level 1710. The high PTH level would also be found to cause the calcium level 1720 to go high, which is shown in FIG. 18. The high calcium level 1720 would normally cause the PTH production to go low at node 1700. However, since this node 1700 has already been set to a high value, the method 1300 will not propagate down this connection because the PTH production node 1700 is in a steady state and does not change during this analysis. In effect, this connection 1800 is ignored, which is why it is shown in dotted lines in FIG. 18.

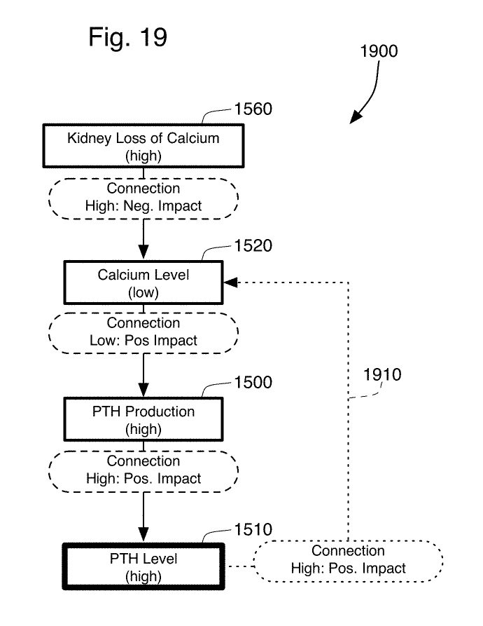

Similarly, FIG. 19 shows a second scenario 1900 in which kidney loss of calcium 1760 is considered a potential root cause node. This node 1760 was found by examining parent nodes in method 1300, and effect propagation fills out this scenario 1900. In this case, the connection 1910 from the PTH level node 1710 where a high value causes an increase in the calcium level 1720 is not considered because the calcium level 1720 is already determined to be low during the creation of this scenario.

### Method for Test and Treatment Identification

In analyzing one or more inputted findings or symptoms, the analysis programming 160 uses method 1300 to develop a set of explanatory scenarios and uses method 1500 to determine the relative likelihood for each scenario. The resulting scenarios can be presented to the user based on the determined relative likelihood. While such a presentation of possible root causes or diagnoses for a given situation is useful, analysis programming 160 can provide much more utility. In particular, system 100 is able to suggest specific actions designed to either determine which diagnosis is correct or to begin treating the problems. This is possible because of the test layer 1110 and because of the presence of modifiable nodes in the knowledge repository 140.

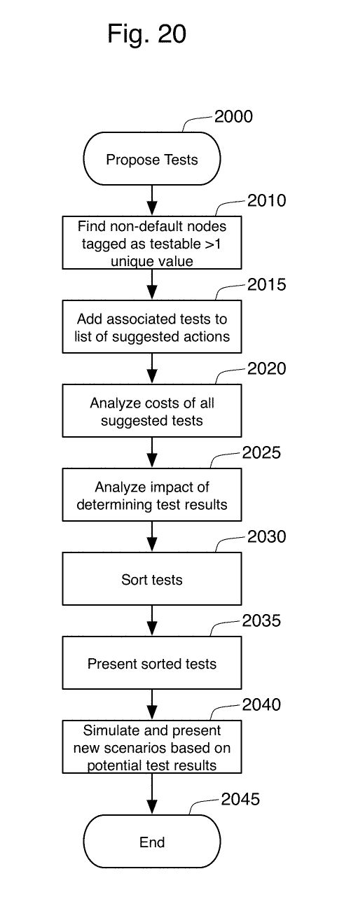

The process 2000 for proposing tests is set forth in FIG. 20. The first step is to find nodes in any scenario in the proposed explanatory scenarios that are both tagged as testable and which have more than one unique value across scenarios. As explained above, through the process of effect propagation, each presented scenario contains predictions about the consequences of the identified potential root causes. These predictions are the values of nodes downstream of the predicted root cause. Consequently, each presented explanatory scenario contains different predictions on the non-default values of these downstream nodes. Step 2010 determines which of these downstream nodes have been tagged by the knowledge repository 140 as “testable.” Note that the set of downstream nodes will include the root cause node, as that root cause may itself be testable. If a node value is the same in every scenario, then a test which observes it would not be helpful in filtering down possible scenarios. Scenarios without a node definition are assumed to have default values.

As explained above, nodes are tagged as testable because of the existence of tests 1100 in the test layer 1110 that can observe the value of these nodes. In a medical context, doctors can use a variety of means to determine the value of a testable node, such as having a doctor ask a patient a question, perform a physical exam maneuver, or by taking a blood or urine test, or by acquiring and analyzing medical images. When testable node predictions are found in step 2010, the tests that observe these predictions are added to a list of actions to be suggested to the user in step 2015. Because different tests can have a wide range of economic costs, the cost for each of the identified tests is considered at step 2020.

As is explained in more detail below, it is also possible to analyze the change in expected treatment effect after test results due to a change in the top recommended treatment option. This impact is analyzed and added to the information about the test in step 2025. At step 2030, information about the tests costs and improved treatment impact are analyzed to create a sorted list of suggested tests in step 2030. Useful, inexpensive tests are ranked higher than expensive tests that are less likely to be relevant. The ordered set of tests are then presented to the user through a user interface in step 2035. Through this interface, the user can access information about the test that is recorded in the knowledge repository 140 such as the cost and effects of doing the test. The algorithm can also simulate what the new suggested explanatory scenarios would be if different values of the nodes which the test observes were to be added to the list of current patient findings. A user can request such simulations and be presented with the resulting scenarios in step 2040. Foreshadowing what the consequences of doing the tests would be is very helpful for a doctor, and is an effective way of communicating the value of the tests. The method ends at step 2045.

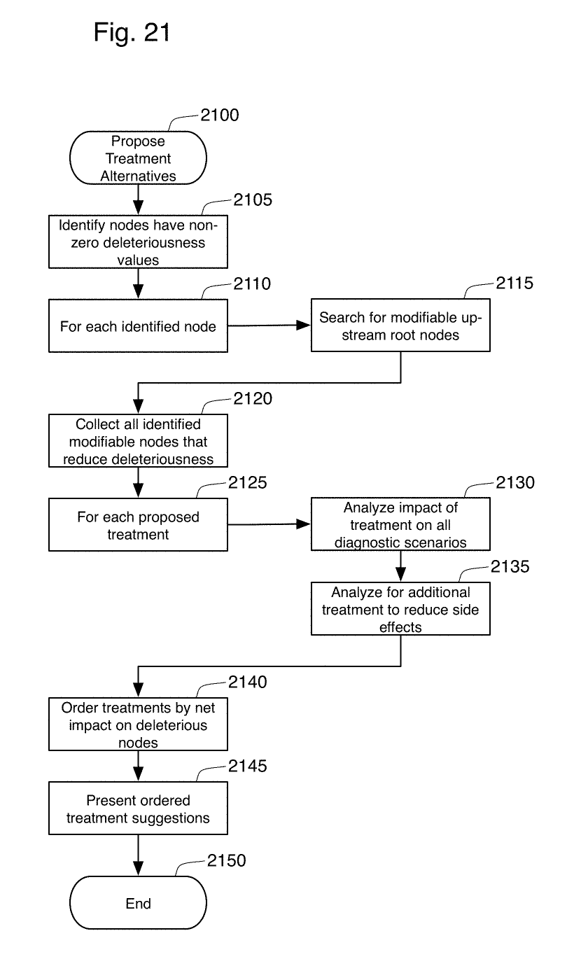

The method for proposing treatment alternatives 2100 is set forth in FIG. 21. As explained above, the nodes in a medical knowledge repository 140 may include modifiable nodes that relate to medicinal drugs, surgeries, lifestyle changes, etc. The system 100 can simulate the chances of positive and negative impacts of modifying these modifiable nodes, and if the impact has a net expected improvement in the sum deleteriousness of the predicted resulting scenarios, personalized based on what is known about the patient, the modification can be suggested. Of course, in the medical realm, a doctor and patient will together make the decision on whether or not tests or treatments are appropriate, but system 100 can nonetheless provide meaningful suggestions together with helpful personalized information.

The method 2100 begins by analyzing each scenario to identify any node value which has a non-zero deleteriousness amount in the node definition at step 2105. These nodes will be analyzed for candidate treatments that are predicted to cause that node to have a less deleterious value, ideally its default value in the population. To do this, an analogous search is made as in the original root cause method 1300 for a root node and value that could cause this deleterious node to go from its current value to its default value. The same “what causes this?” method described in connection with FIG. 13 is used recursively to determine what nodes which have connections to a target node could together explain this desired change in value of the deleterious node. However, only nodes that are labelled “modifiable” are considered as potential root nodes in this search. This search is conducted in step 2015. Once this search is conducted for the identified deleterious nodes, a set of possible modifiable nodes are collected in step 2120 that have been determined to be able to cause the intended deleterious node value to change to a less deleterious value. These collected nodes are the possible treatments that can reduce the sum deleteriousness of the collected nodes in the scenario, including the chances of predicted side effects propagated downstream of the treatments. Because the knowledge repository 140 encodes relationships where two source nodes may be required to cause an intended target value change, each treatment derived may actually be a set of more than one modifiable changes which are required to happen together.

A doctor doesn't always wait to be 100% certain of a diagnosis before attempting a treatment. There is always a small chance that the most likely explanation for a set of symptoms is wrong, and the symptoms are actually caused by a very rare disease which requires a different form of treatment to be effective. There is also a possibility that what they don't know yet about the patient could cause a disastrous side effect from their treatment, such as an unknown allergy or a multitude of other predispositions. These possibilities shouldn't hold a doctor back from taking action when the chances of inefficacy or bad consequences are low. The method to propose treatment alternatives 2100 can assist the doctor in analyzing the various possibilities and the likelihood of each possibility by calculating the risks of various treatment suggestions. After each treatment set is derived, each explanatory scenario from the most likely to the least likely are analyzed by setting the treatment suggestion node values to their new states and propagating their effects into weighted effect scenarios which include the most likely effects and rare side effects. Step 2125 requires that, for each proposed treatment identified in step 2120, this impact is analyzed in step 2130.

In some cases, a proposed treatment can have significant deleterious side-effect impact, but this impact can be lessened if the treatment were combined with an additional treatment designed to minimize the side effects of the original treatment. In some embodiments, the analysis of the potential treatments in step 2130 is accompanied by analyzing potential secondary treatments that might reduce those side effects in step 2035.

The results of the analyses in steps 2130 and 2135 are then weighed, taking into consideration the relative chance of the original scenario being correct in the original finding search, and the chance of the treatment having a given effect. The potential treatments are valued based on the efficacy of the suggested treatments in reducing a patient's deleterious node values and the chances of a number of predicted deleterious side effects happening. In effect, the net likely reduction in deleterious node values is calculated in step 2140, and the proposed treatments are then ordered based on the results of that calculation. In step 2145, the ordered treatments are presented to the user in the context of the treatment being a suggested action. The process 2100 ends at step 2150

In order to rank treatments and tests, their value must be calculated. For treatment sets, their value can be determined by first finding the average total of the deleterious scores of all node values in each scenario, weighted by the relative chance of each scenario. Then, for each treatment, the average deleterious score of all node values of all predicted effect scenarios is calculated, weighted by the relative chance of each effect scenario. Any treatment with more deleteriousness/harm/suffering predicted on average afterward than was predicted to exist before (worse side effects than the original problem) are eliminated. Treatments can then be sorted by how much they are predicted to reduce average suffering. Additionally, since node value modifiability definitions are each associated with costs, total treatment cost minimization can be used to sort treatments with equal harm reduction, or cost can be associated with a deleteriousness factor and weighted together with harm reduction for prioritizing treatment suggestions.

The value of tests in reducing harm can also be predicted. Without additional information, treatments which are considered to be given immediately must be weighed by their effects across all possible explanatory scenarios, even ones which they aren't expected to be effective in reducing suffering. However, a test can be expected to add clarity about which explanatory scenarios are the true scenarios, and thus filter the set down and allow for different treatments to be given based on the test results, and improve the efficacy of treatment. In this manner, the value of tests can be evaluated by calculating the expected improvement in treatment efficacy when treatments are given after a test result is known versus starting treatment without the test information. This can be done by splitting the original explanatory scenarios into groups based on common values of the states which a test observes. The cumulative probabilities of the scenarios in each group over the total scenario set probability indicates the relative probability of the test having a given result. For each scenario set filtered by each test result, the treatment which reduced net harm the most can be found. Finally, the test value can be given by the difference between the net harm reduction of the top treatment across all the original explanatory scenarios before test results were known from the average harm reduction of treatments chosen for each subset of the explanatory scenarios after test results are known, weighted by the chances of those test results. This effectively values each test by its ability to change how a patient should be treated, and the net improvement of that change in treatment. Additionally, if a test definition includes a required effect (such as giving a contrast agent as a part of a medical imaging test), then the effects of that node modification are included in each scenario from the start. In this way, the potential side effects of a test (which are higher in a person with a known contrast allergy in their set of findings), can be added to the expected harm in the scenarios, but does not rule out that test as in cases of emergency can necessitate that the value of the test outweighs this expected harm. The delay in treatment with a test is also included based on the time delay in a test's definition which is incorporated into the scenarios after a test is given and compared to the original anticipated harm reduction is a treatment is given right away, which can be essential in emergency situations. Test cost is also a part of its definition and can be used to rank tests of an otherwise equivalent harm reduction value or cost itself can be assigned a harm equivalency and weighed along with the results of the test.

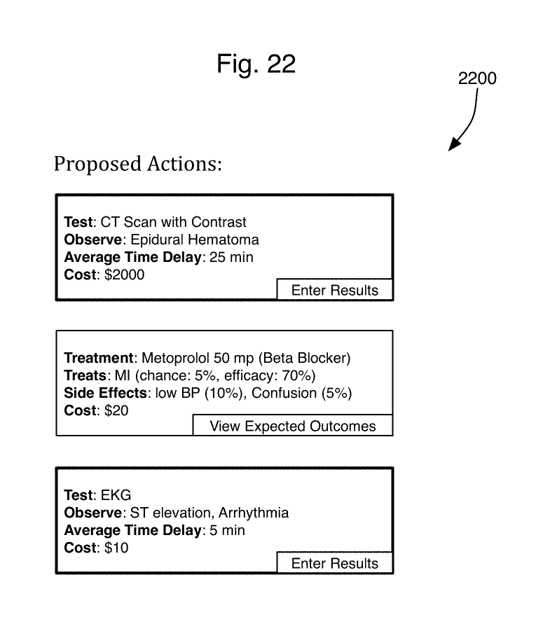

Together, tests and treatments can be presented in a list of action suggestions 2200 as illustrated in FIG. 22, ranked by the value of these actions to the patient given how the original patient findings were interpreted. Test suggestions can include information about the test itself, the cost, and the specific nodes that make it useful to observe for the given patient. A doctor can also directly use that tab to add information from the test once it is known to the set of patient findings to re-evaluate explanatory scenarios and next actions. Treatments can be suggested with information about the treatment, the test cost, as well as the anticipated utility of the test for treating node values which are defined as being deleterious, and the predicted risk of side effects of giving the treatment. Deleterious node values which the treatment may be suggested to treat, may be only present in a subset of explanatory scenarios (represented by the chance in FIG. 10 of the MI being treated). However, the gravity of the deleteriousness is weighed by the relative chance of the scenarios being correct as well as the net low harm in giving a treatment in the cases where it isn't present, thanks to the comprehensive calculation of the predicted value of the treatment.

Thanks to connections having the ability to predict future consequences of actions, the long term potential effects of treatments can be propagated. Additionally, sequences of actions including tests and treatments can be simulated and overall sequences of actions can be weighed. In this way, complicated choices which doctors have to make such as doing a blood test before anticoagulating, or a sampling a blood culture before giving antibiotics can be simulated based on how the action of anticoagulation or giving antibiotics would be expected to reduce the ability of the test to identify the true coagulopathy or bacteria if done after treatment as the nodes it observes would be affected and masked.

The many features and advantages of the invention are apparent from the above description. Numerous modifications and variations will readily occur to those skilled in the art. Since such modifications are possible, the invention is not to be limited to the exact construction and operation illustrated and described. Rather, the present invention should be limited only by the following claims.

What is claimed is:

1. A method for establishing an expert system in a computer system comprising:
a) establishing a plurality of nodes, each indicating a property in a system, wherein each node comprising:
i) a default value,
ii) an assigned value, and
iii) a unique node identifier;
b) establishing a plurality of connections, each connection connecting a source node to a target node, wherein each connection further comprises impact data indicating an impact that the assigned value of the source node has on the assigned value of the target node;
c) receiving a first input value for a first input node;
d) determining potential root cause nodes for the input node by
i) selecting the first input node as a selected node with the first input value as a selected value,
ii) identifying a set of connections having the selected node as the target node,
iii) identifying a subset of connections having impact data capable of causing a change from the default value of the selected node to the selected value in the selected node,
iv) identifying, for the subset of connections, source nodes and source node assigned values sufficient to cause the selected value in the selected node, and
v) recursively applying steps d)ii) through d)iv) with the identified source nodes as the selected node until root nodes and their respective root values are identified that have no source nodes identified in step d)iv);
e) performing effect propagation to evaluate the impact of the root nodes having the root values on other nodes;
f) combining the evaluations of step d) and e) into a causation scenario; and
g) presenting the causation scenario.

2. The method of claim 1, wherein the step of receiving the first input value for the first input node comprises receiving a set of input values for a set of input nodes; further wherein the first input value is a non-default input value; and still further wherein a second input value for a second input node is a default value.

3. The method of claim 2, wherein the assigned value of each node is an assigned numeric value, and each node further comprises a discrete value selected from a set of possible discrete values for the node, the discrete value being determined from the assigned numeric value.

4. The method of claim 3, wherein the discrete value is determined using predetermined divisions that divide the assigned numeric value into the set of possible discrete values.

5. The method of claim 3, wherein the impact indicated by the impact data is determined by the discrete value for the source node.

6. The method of claim 5, wherein the impact indicated by the impact data for a particular discrete value is determined by a probability analysis.

7. The method of claim 6, wherein the probability analysis is based on a plurality of percentage/delta pairs for the particular discrete value.

8. The method of claim 3, wherein the impact varies for each of the discrete values, further wherein probabilities are assigned to different impacts for a single discrete value, and further wherein the root nodes each have a root probability for having their respective root value.

9. The method of claim 8, further wherein the causation scenario is assigned an absolute probability by multiplying the root probability by the probability of the connections in the scenario having sufficient impact on their target nodes to cause the non-default input value for the first input node without causing the second input node to have a new, non-default value.

10. The method of claim 8, wherein multiple causation scenarios are presented, with each causation scenario having its own absolute probability, further wherein each causation scenario has a relative probability determined by comparing that scenario's absolute probability to the absolute probabilities of the other causation scenarios.

11. The method of claim 3, wherein a default node represents a first property in the system and has a first set of possible discrete values, wherein a conditional node representing the same first property in the system and has the same first set of possible discrete values, and further wherein the conditional node further comprises a different relationship between the first set of possible discrete values and the assigned numeric value, and still further wherein the conditional node comprises applicable conditions indicating node identifiers and values that must exist for the conditional node to supersede the default node.

12. The method of claim 11, wherein a default connection and a conditional connection both connect the same source node to the same target node, wherein the conditional connection has different impact data than the default connection, and still further wherein the conditional connector comprises applicable conditions indicating node identifiers and values that must exist for the conditional connector to supersede the default connector.

13. The method of claim 2, wherein multiple root cause nodes are identified and divided into a plurality of presented causation scenarios.

14. The method of claim 13, wherein a single causation scenario comprises multiple root causes, wherein the multiple root causes are required for the impact of the identified source nodes to be sufficient to cause the first input value for the first input node.

15. The method of claim 13, wherein separate causation scenarios are grouped together based on shared nodes having shared values.

16. The method of claim 15, wherein only a portion of the plurality of causation scenarios are presented in step g) based on a likelihood probability assigned to each causation scenario.

17. The method of claim 13, further comprising the step of establishing a plurality of tests, each test identifying testable nodes whose assigned values can be determined by the test.

18. The method of claim 17, wherein the presentation of the causation scenarios further comprises identifying testable nodes that have a plurality of predicted values in the causation scenarios.

19. The method of claim 18, wherein each test has a cost, further wherein the value of performing the test on the scenarios is evaluated, and further wherein the tests are sorted according to the costs and value of the tests.

20. The method of claim 18, further comprising simulating the results of a particular test by adding the assigned value of a testable node to the set of input values and determining the impact of the assigned value on the causation scenario results.

21. The method of claim 1, wherein a set of nodes are marked as modifiable, further wherein a first node in the causation scenario is determined to be deleterious at its assigned value, further comprising the steps of:
i) identify a change in assigned value of the first node that reduces the deleteriousness of the first node value,
ii) analyze connections that have the first node as the target node so as to identify ancestor nodes that are both modifiable and can be changed to a new assigned value that is sufficient to cause the change in value in the first nodes, and
iii) present the identified ancestor nodes as treatment nodes that potentially can treat the deleteriousness of the first node.

22. The method of claim 21, wherein multiple nodes are determined to be deleterious and multiple treatment nodes are identified.

23. The method of claim 22, wherein the treatment nodes are root nodes marked as modifiable.

24. The method of claim 22, further comprising performing effect propagation on the treatment nodes to identify deleterious node value changes as negative side effects of modifying the assigned value of the treatment node.

25. The method of claim 24, where the multiple treatment nodes are sorted based on the deleteriousness of modifying the assigned value of the treatment node including negative side effects and impact to the first node.

26. The method of claim 1, wherein the nodes and connectors form a non-Bayesian network including a directed loop in the network, wherein root nodes are identified in the loop by not changing the assigned value in a node after a first change and stopping traversal of the loop when a node would require a change in the assigned value after the first change.

27. The method of claim 1, wherein a first set of connectors are time-based, requiring time before the impact of the impact data alters the assigned value of the target node, further comprising a plurality of non-default input values, each being associated with a different time, to analyze the potential changes to assigned values over time.
